(19) United States
(12) Patent Application Publication
(10) Pub. No.: US 2012/0268315 A1
(43) Pub. Date: Oct. 25, 2012

(54) WIDE AREA DETECTION OF INSECTS USING REFLECTED MICROWAVES

(76) Inventors: Anatol Zymunt Tirkel, East Brighton (AU); Gerard Anthony Rankin, Royston Park South Australia (AU); Nicholas William Desmond Le Marshall, Yarraville Victoria (AU)

(21) Appl. No.: 13/500,613

(22) PCT Filed: Oct. 21, 2009
(86) PCT No.: PCT/AU2010/001392

§ 371 Date: Jun. 5, 2012

(30) Foreign Application Priority Data
Oct. 21, 2009 (AU) 2009905128

(51) Int. Cl. G01S 7/04; G01S 13/00

(52) U.S. Cl. 342/147; 342/179

(57) ABSTRACT

An insect detection system including a transmitter array (201) for transmitting microwave signals into a region, a far field receiver array (202) for receiving far field signals reflected or scattered from the region illuminated by the transmitted microwave signals, a processor (500) for processing the received microwave signals; and a display for displaying images according to the processed far field signals.

### FIELD OF INVENTION

The invention relates to an insect detection system which utilises microwave radar. In particular, the invention relates to an insect detection system with wide area detection capabilities.

### BACKGROUND TO THE INVENTION

In nature termites, otherwise known as white ants, assist in the recycling of organic matter and nutrients back to the soil. However should they invade a building they can seriously damage the integrity of timber structures. There are over 350 species of termites in Australia of which some 20 species can damage timber in houses.

Termites avoid light and rarely come out into direct light. As a result, termites often leave a wafer thin layer to protect themselves from the outside environment. Sometimes they conceal themselves within mud-like tubes or galleries, but commonly termites conceal themselves within building walls, ceilings and floors and are hidden from view.

In order to prevent significant damage, home owners should conduct regular pest or termite inspections. Microwave detection systems have been developed to detect the presence of termites hidden within walls, ceilings and floors of buildings. Current detection systems have been successful in detecting termite movement. Termites are distinguished from their surroundings by exploiting their backscatter to detect their movement.

Australian Patents AU 693039 and AU 2003249770 describe such detection devices, which employ the method of transmitting a microwave signal into walls, ceilings or floors. Reflected signals are detected by a receiver and then passed to a processor, which analyses disturbances in the received signal.

Australian Innovation Patent AU 2008101237 discloses a system and method of detecting and/or imaging insects utilising near field signals. However to scan an entire wall using this method is time consuming and laborious. This is because the area illuminated is relatively small in the order of 10-100 cm².

In order to illuminate a greater area of the surface to be inspected, it is necessary to move a radiating source further away. However due to the reduction in power density, received signals are reduced to below the noise floor of the system.

### OBJECT OF THE INVENTION

It is an object of the invention to overcome or alleviate one or more of the above disadvantages and/or to provide the consumer with a useful or commercial choice.

### SUMMARY OF THE INVENTION

According to one aspect, the invention relates to an insect detection system including:

a transmitter array that transmits microwave signals into a region;

a far field receiver array that receives far field signals reflected or scattered from the region illuminated by the transmitted microwave signals;

a processor that processes the received microwave signals; and

a display that displays images according to the processed far field signals.

Optionally, the insect detection system includes a near field receiver array that receives near field signals reflected from the transmitted microwave signals. Suitably, the received near field signals are processed and displayed on the display according to the processed near field signal.

Preferably, at least one of the transmitter array, the near field receiver array and the far field receiver array are fabricated on at least one printed circuit board.

The transmitter array, the near field receiver array and the far field receiver array may include a plurality of patch antennas. Preferably, each patch antenna includes two substantially orthogonal elements. Suitably, the orthogonal elements transmit or receive arbitrary polarisations of the microwave signals

Preferably, each transmitted microwave signal is modulated in time and, usually, the modulation is In-phase/Quadrature (IQ) modulation.

Optionally, the transmitter array is calibrated using a calibration target. As a result of the calibration a signal of equal and opposite phase to a signal coupling patch antennas, may be applied to each patch antenna to reduce imperfections in the transmitter array.

Preferably, each substantially orthogonal element of the transmitter array, transmits microwave signals encoded with orthogonal codes. Suitably, the orthogonal codes may be derived from a Hadamard matrix. Preferably, the transmitted microwave signals are constructed from cyclic shifts of a pseudo-noise sequence, for example, a quadratic residue sequence (binary Legendre sequence) to which one extra bit has been appended. Suitably, the orthogonal codes have low off-peak autocorrelation and can therefore be used to extract weak signals from noise by correlation.

Preferably each received signal is compared to the transmitted signal by matching the orthogonal codes. Suitably, the compared signal is used to determine whether the received signal is due to an insect or part of a building structure being examined.

A signal strength of the received microwave signals at a patch antenna, x(m:n), in the far field receiver array with an element spacing of Δₓ, Δ_{y}, may be represented by the following equation:

$$x ( m \text{:} n ) = {\sum }_{i = 1}^{1} {A}_{i} exp ( {jγ}_{i} + j 2 π n {Δ}_{y} sin {θ}_{i} sin {ψ}_{i} + j2π m {Δ}_{x} sin {θ}_{i} cos {ψ}_{i} )$$

Preferably, the received microwave signal from each patch antenna is assembled into an enhanced matrix using a partition and stack process.

Preferably an estimate of a number of insects is made by applying a Singular Value Decomposition (SVD) to the enhanced matrix to determine signal and noise spaces. Suitably, eigenvalues associated with the signal subspaces may be determined by matrix inversion.

Preferably, each encoded far field or near field signal received by the substantially orthogonal elements, is decoded by correlation and/or applying the reference Hadamard matrix. Suitably, each encoded received far field or near field signal is arranged according to each code.

Preferably the far field image processing includes a direction of arrival (DOA) method for image acquisition. Suitably the DOA method uses a Modified Enhanced Matrix Pencil algorithm, although any one of similar DOA techniques could be applied. The signals from each transmitter element may be beamformed at the receiver before the processing by the DOA algorithm.

Preferably, the transmitter signal beamforming is performed to null out undesirable targets, artefacts, reflections and/or clutter.

Suitably a Chebyshev filter cancellation algorithm is used to reduce signals from unwanted directions in conjunction with transmitter beamforming before processing by the DOA algorithm. The signal cancellation and/or beamforming may be performed adaptively.

In another aspect, the invention resides in a method of detecting insects including the steps of:

transmitting microwave signals into a region;

receiving far field signals reflected or scattered from the region illuminated by the transmitted microwave signals;

processing the received microwave signals; and

displaying images according to the processed far field signals.

Preferably, the method includes the step of modulating the transmitted microwave signal.

Preferably, the method includes the step of applying a signal of equal and opposite phase to a signal coupling patch antennas, to each patch antenna to reduce imperfections in the transmitter array.

Suitably, the method includes the step of encoding each substantially orthogonal element of the transmitter array with orthogonal codes.

### BRIEF DESCRIPTION OF THE DRAWINGS

In order that the invention may be readily understood and put into practical effect, reference will now be made to preferred embodiments in which:

FIG. 1 shows a block diagram of an insect detection system according to an embodiment of the present invention;

FIG. 2 shows a block diagram of an antenna array of FIG. 1 according to a first embodiment of the present invention;

FIG. 3 shows a schematic of a patch antenna according to an embodiment of the present invention;

FIG. 4A shows a graph of scattered and absorbed signals, end-on to a spheroid;

FIG. 4B shows a graph of scattered and absorbed signals, side-on to a spheroid;

FIG. 5 shows a block diagram of a transmitter according to an embodiment of the present invention;

FIG. 6 shows a block diagram of a receiver according to an embodiment of the present invention;

FIG. 7 shows a block diagram of a processor according to an embodiment of the present invention; and

FIG. 8 shows a block diagram of an antenna array according to a second embodiment of the present invention.

### DETAILED DESCRIPTION

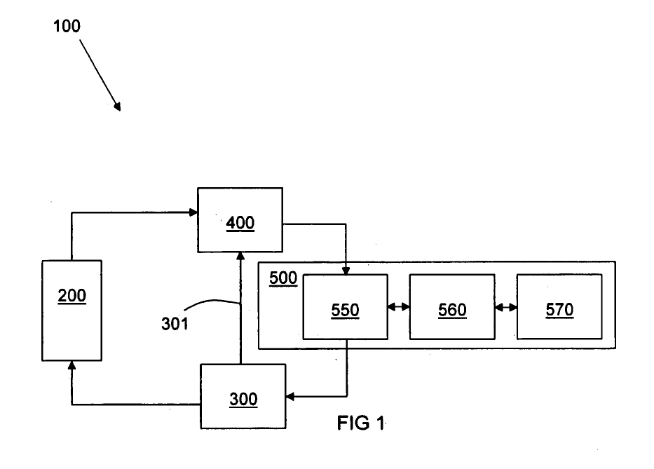

FIG. 1 shows a block diagram of an insect detection system 100 according to an embodiment of the present invention. The system 100 includes an antenna array 200 (incorporating a transmitter array, a far field receiver array and a near field receiver array), a transmitter 300, a receiver 400, and a processor 500 (incorporating an FPGA 550, a CPU 560 and a computer 570).

The transmitter 300 sends microwave signals to the antenna array 200 which are transmitted into an area for the purpose of detecting insects such as termites. Received signals are received by the antenna array 200, demodulated by the receiver 400 and processed by the FPGA 550 and the CPU 560. The processed signals are then displayed on a screen of the computer 570 in a way that would be understandable by an operator of the system 100.

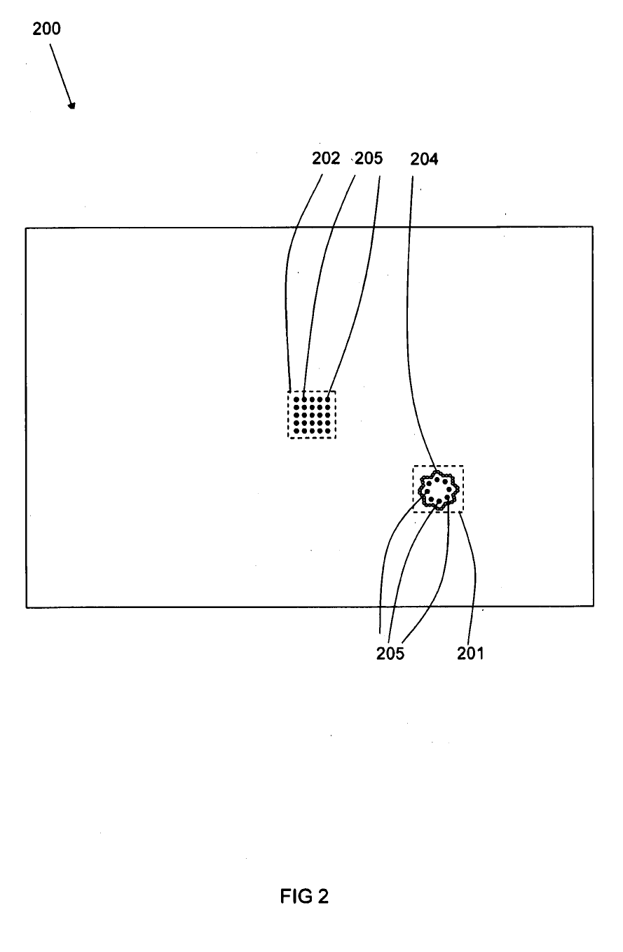

FIG. 2 shows a detailed schematic diagram of the antenna array 200 according to a first embodiment of the present invention. The antenna array 200 includes a transmitter array 201 and a far field receiver array 202. The antenna array 200 is fabricated on a printed circuit board (PCB). However a person skilled in the art will appreciate that the transmitter array 201 may be fabricated on a separate printed circuit board to the far field receiver array 202. Each array 201, 202 includes a plurality of patch antennas 205.

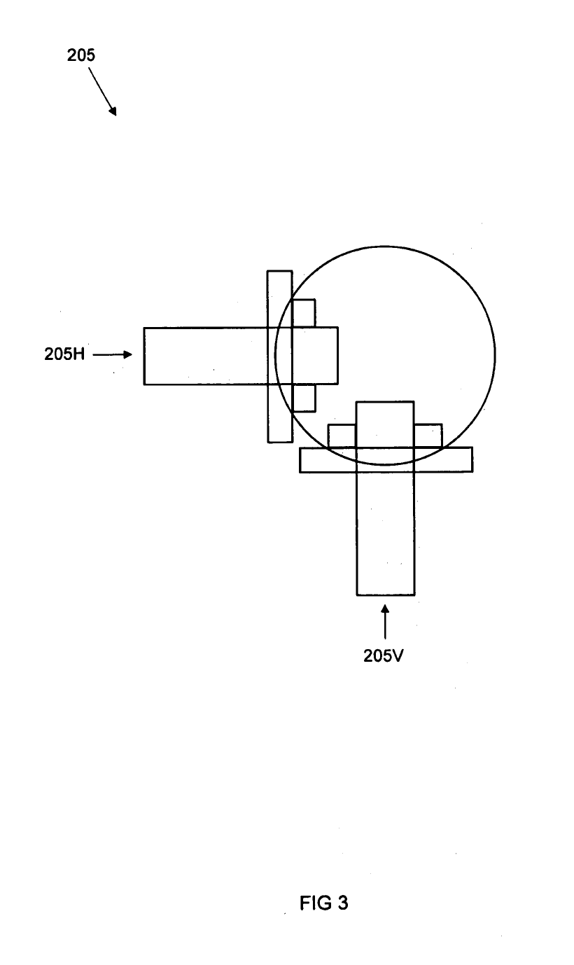

FIG. 3 shows a PCB layout of a patch antenna 205 according to an embodiment of the present invention. Each patch antenna 205 includes two substantially orthogonal elements, to transmit or receive arbitrary polarizations of the microwave signals. In one embodiment each patch antenna 205 includes a horizontally polarised element 205H and a vertically polarised element 205V however it should be appreciated that the elements 205H, 205V may be at other relative angles depending on whether the measurement is of a wall, ceiling or floor. A detailed description of the patch antennas is described in Australian innovation patent no. 2008101237 which is herein incorporated by reference.

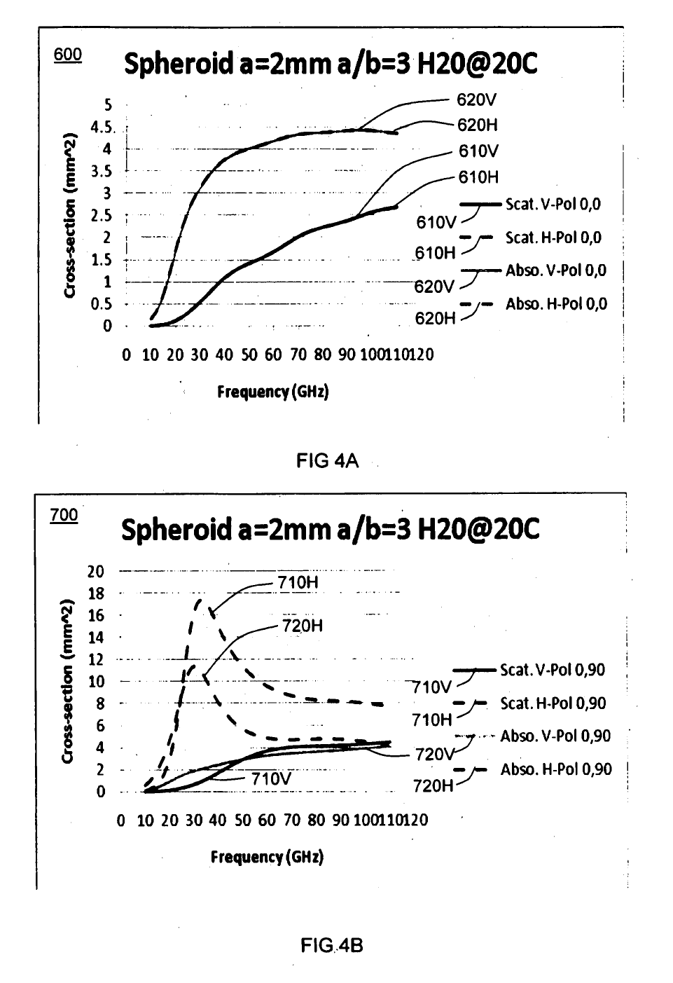

Dual polarisation patch antennas 205 are used, as building materials exhibit anisotropic properties at 24 GHz. Anisotropy causes differences in the relative magnitudes and phases of the electric field of the received signal depending on the orientation of the antenna array with respect to the principal axes of the building material. Variations in the imaginary part of the dielectric constant cause variations in the amplitudes of the received signal, whilst variations in the real part cause phase variations. Thus the polarisation of a received signal transmitted through a wall, reflected from a target and through the wall to the receiver is complex and unpredictable. Due to the dual polarisation of the patch antennas 205, the transmitted signal can have any polarisation on the Poincaré sphere by applying suitable complex signal weights to the transmitted signal. Complex signal weights may alternatively be applied to the received signal as each signal has a different orthogonal code and may be compared to the transmitted signal by matching the orthogonal codes. Due to the dual polarisation of each patch antenna, the received signal can be analysed independently of the transmitter polarisation. This technique may also be used to determine a polarisation signature of a scatterer to determine whether the scatterer is an insect or part of the wall being measured. The polarisation signature of a scatterer is demonstrated in FIGS. 4A and 4B.

FIG. 4A shows a graph 600 of scattered 610V (vertical polarisation), 610H (horizontal polarisation) and absorbed 620V (vertical polarisation), 620H (horizontal polarisation) signals end-on to a spheroidal object (rugby ball shaped). As the end on cross-section of a spheroid is symmetrical (circular), scattering and absorption of signals due to the spheroid in both the horizontal and vertical polarisations are the same for a particular frequency. This is equivalent to a signal being reflected from a part of the wall.

FIG. 4B shows a graph 700 of scattered 710V (vertical polarisation), 710H (horizontal polarisation) and absorbed 720V (vertical polarisation), 720H (horizontal polarisation) signals side-on to a spheroidal object. As the side-on cross-section of the spheroid is asymmetrical, the scattering and absorption of a signal in both the horizontal and vertical polarisations is different depending on the frequency. This appears to be because the signal excites different resonances depending on the aspect angle and the polarization, resulting in different signal strengths received at a patch antenna 205. This is equivalent to a signal being reflected from a termite.

Without being bound to any particular theory, it appears the true nature of the resonances is complex and involves matching E and H fields at the boundary of the dielectric. This results in solutions which have a denominator, which is a difference of two Bessel functions (inside the dielectric) or two Hankel functions (outside the dielectric). The resonances occur when the denominator is zero. This mathematical description is accurate, but does not lead to any insight. Therefore people have tried to make this more physical. Outside the dielectric these resonances are called creeping wave resonances, although they are really waveguide modes. Inside they are called whispering gallery modes. The name creeping wave is used despite the fact that creeping wave theory from the geometrical theory of diffraction is now discredited. This is because it does not work all the time. It has been replaced by the physical theory of diffraction, which is physical optics plus edge currents. It is edge currents which drive the waves from the illuminated side of the object into the dark side.

By measuring the difference between a vertically polarised received far field signal and a horizontally polarised received far field signal, with the same orthogonal code, it is possible to determine whether the received far field signal is due to an animate object such as a termite or an inanimate object such as a part of a structure.

Referring to FIG. 2, in one embodiment, the transmitter array 201 includes a circular array of 8 patch antennas 205, however it should be appreciated that any number of patch antennas may be used. Typically, the transmitter array includes between 8 and 32 patch antennas 205. Although the transmitter array 201 is circular, it should be appreciated that the transmitter array 201 may form any other applicable design. A star shaped ring of vias 204 surround the transmitter array 201 to reduce coupling between the transmitter array 201 and the far field receiver array 202. Again it should be appreciated that the ring of vias 204 may be any suitable design.

The far field receiver array 202 includes a square array of 25 patch antennas 205 arranged in a 5×5 square array. Again, it should be appreciated that a person of ordinary skill in the art would appreciate that other designs of far field receiver array 202 are possible.

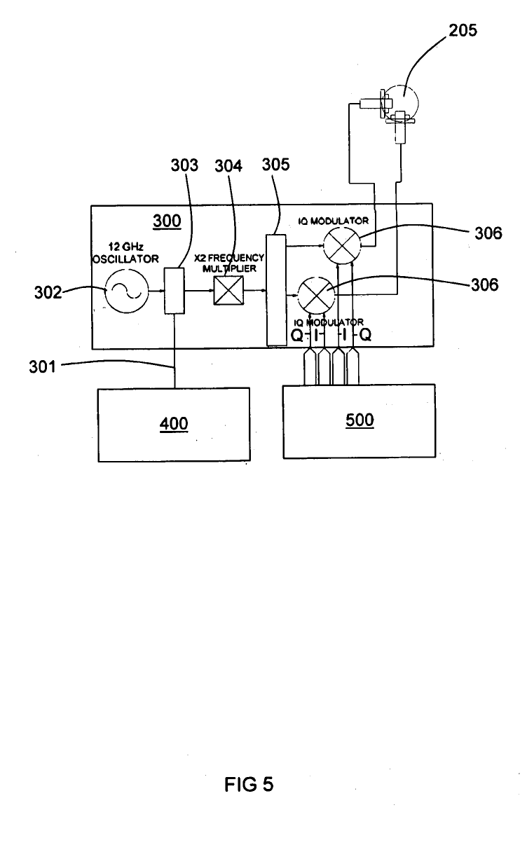

FIG. 5 shows a block diagram of the transmitter 300 according to an embodiment of the present invention. The transmitter 300 includes an oscillator 302, a first splitter 303, a frequency multiplier 304, a second splitter 305, and a number of In-Phase/Quadrature (IQ) modulators 306.

In one embodiment the oscillator 302 operates at 12 GHz however a person skilled in the art would appreciate that any suitable oscillator frequency may be used. The 12 GHz signal is split using a first splitter 303. One half of the 12 GHz signal is communicated to the frequency multiplier 304 and the other half provides a local oscillator signal 301 to the receiver 400. The frequency multiplier 304 multiplies the 12 GHz signal by two, creating a 24 GHz signal which is connected to the second splitter 305. The 24 GHz signal is split into twice the number of patch antennas 205 because each patch antenna 205 has a horizontal and a vertical feed. In one embodiment the number of patch antennas 205 used in the transmitter array 201 is eight, therefore, the 24 GHz signal is split into sixteen equal signals. Each of the sixteen 24 GHz signals is first given a unique code, (which will be described in detail later) and modulated by an IQ modulator 306. The frequency of the IQ modulation is 20 kHz generated by the processor 500. It should be appreciated the IQ modulation may be any other suitable frequency. An encoded and modulated 24 GHz signal is connected to the horizontally polarised element 205H and the vertically polarised element 205V of each patch antenna 205. Each IQ modulator 306 modulates the 24 GHz carrier with an in-phase (I) and a quadrature phase (Q) component as is known in the art.

In order to reduce mutual coupling between transmitter elements, the transmitter array 201 is initially calibrated by placing a calibration target, such as a modulated scatterer in front of the antenna array 200. Mutual coupling results in undesirable crosstalk, and errors in transmitter beamforming. The signal coupled between any pair of elements is measured as a magnitude and a phase. A signal of equal amplitude and opposite phase is then applied to each transmitter element according to the measured signal.

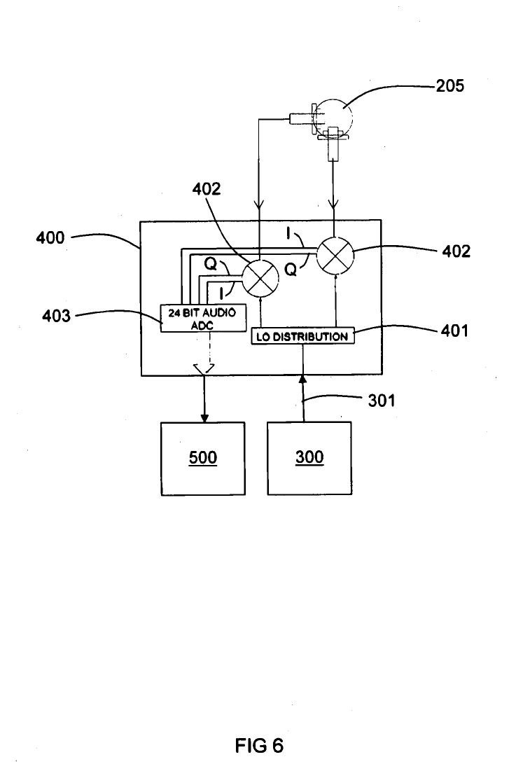

FIG. 6 shows a block diagram of the receiver 400 according to an embodiment of the present invention. The receiver 400 includes a splitter 401, a number of demodulators 402, and analogue to digital converters (ADC) 403. The local oscillator signal 301 from the transmitter 300 is connected to splitter 401 and divided into an equal number of signals according to twice the number patch antennas 205 in the far field receiver array 202. Each received signal is demodulated by the demodulators 402 to extract the I and Q signal. Each I and Q signal is then converted to a digital signal by the ADC 403 and the digitised signals are passed to the processor 500 for analysis. It should be appreciated, that the received signals may be multiplexed or individual receivers 400 used. In the present embodiment, microwave signals received by the far field receiver array 202 are fed into individual receivers 400. Each local oscillator signal 301 is internally multiplied by two in, the demodulator 402 to 24 GHz as would be understood by a person skilled in the art.

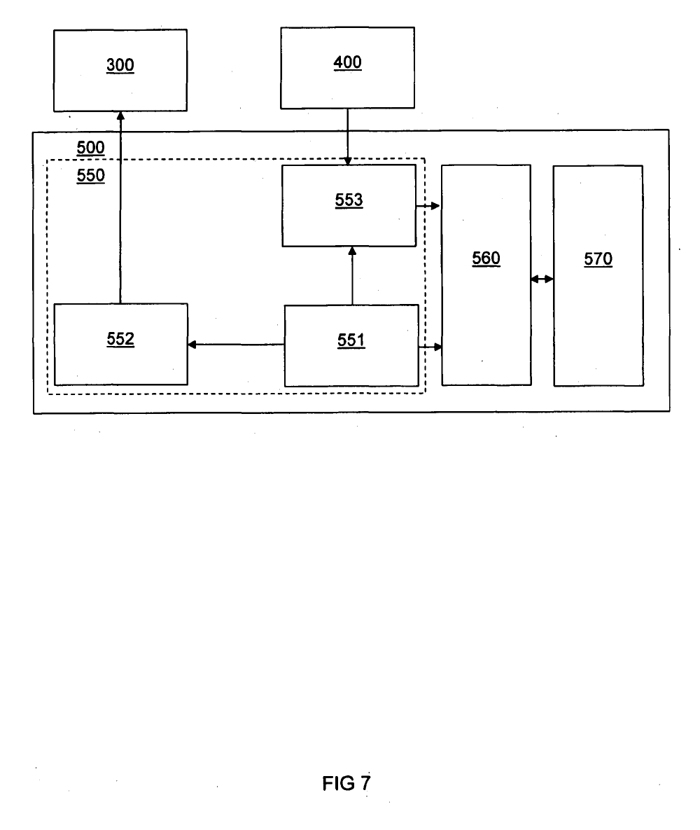

FIG. 7 shows a block diagram of the processor 500 according to an embodiment of the present invention. The processor 500 is used to process transmitted and received microwave signals and in an embodiment of the present invention includes a Field Programmable Gate Array (FPGA) 550, a Central Processing Unit (CPU) 560 and a computer 570. Although the processor 500 includes an FPGA 550 and CPU 560, a person skilled in the art would appreciate that there are many alternative permutations and combinations. For example, the processor 500 may be an Application Specific Integrated Circuit (ASIC) or a single chip processor.

In one embodiment, the FPGA 550 includes an orthogonal code generator 551, Intermediate Frequency (IF) generator 552, and an IF Digital Signal Processor (DSP) and correlator 553. Furthermore, an IF signal generated by the IF generator 552 is 20 kHz, which is high enough to avoid 1/f noise problems and low enough to be adequately sampled by a commercial audio ADC with a 24 bit resolution. It should be appreciated however that the IF signal may be any other suitable frequency.

The orthogonal code generator 551 encodes each 20 kHz IF signal with a unique code and in some embodiments of the present invention orthogonal codes are used. A factor to consider in the code design is spectral equivalence so that any distortion or interference affects all codes equally. Another factor to consider is that the codes are formed from a simple alphabet such as binary. The codes are then constructed into a reference Hadamard Matrix.

In the present embodiment, the codes are applied according to cyclic shifts of a pseudo-noise quadratic residue sequence (Legendre sequence) of length 19 resulting in a 20×20 Hadamard matrix (because one row and one column of a Hadamard Matrix are all 1's, i.e. one extra bit has been added to the sequence). Any sixteen of the 19 codes may be used, one for each of element of each patch antenna 205 in the transmitter array 201. This method of constructing the orthogonal code set is preferred, because, in addition to the cross-correlation of two codes being zero for zero time delay, each of the codes (except the trivial appended code) has good periodic autocorrelation. Without the appended bit, the off-peak auto-correlation is −1 for all non-zero cyclic shifts. The effect of appending the single bit is to allow the off-peak auto-correlation to take on the values: +1, −1, −3. These are still small compared to the peak correlation, which is equal to the code length. This low off-peak autocorrelation can therefore be used to extract weak signals from the noise, by correlation. Thus, these codes can be employed to produce processing gain, and hence increase the Signal to Noise Ratio following correlation. This is similar to the process employed in CDMA communications, GPS navigation and many other wireless systems.

When a set of cyclic shifts of a binary Legendre sequence of length p (where p is a prime number of the form 4k-1) all have an extra symbol of 1 inserted before the p symbols of the Legendre sequence, the set of sequences of length p+1 are all orthogonal at a point, and form rows of a binary Hadamard matrix. They are used as codes in Multiple Input Multiple Output (MIMO) processing. In one embodiment, the rate at which such a code is updated (chip rate) is about 5 kHz. The maximum round trip delay of a microwave signal is of the order of 10 nanoseconds, which corresponds to a negligible fraction of the chip rate. Hence the system 100 is synchronous, and orthogonality of the codes at a point is sufficient.

Each signal received at each patch antenna 205 in the far field receiver array 202 is decoded by the correlator 553 by multiplying each received signal by each of the 16 chosen rows of the Hadamard Matrix. Only the signal relating to a particular code is extracted as any other coded signals when multiplied by the other rows of the Hadamard matrix result in a zero sum. The signals from each transmitter element are then multiplied by appropriate complex weights to form transmitter beams. Many transmitter beams may be formed in parallel within the FPGA 550. Such a process is called beamforming. The purpose of the transmitter beams is to illuminate desired regions with a desired polarisation and to place nulls or zeros at unwanted positions, or out of sector positions, thus increasing the Signal to Noise Ratio (SNR) and reducing interference. Beamforming is also performed to null out undesirable targets, artefacts, reflections and/or clutter. Without beamforming, the weak signals received from termites would not be detectable in the far field at a range of 1-1.5 m. Also, as explained later, the direction of arrival (DOA) algorithm requires a transformation, which works best when the signals are restricted to a sector. The above method provides such a means.

The beamformed signals are then analysed using a Direction of Arrival (DOA) algorithm. In one embodiment, the DOA algorithm is a Modified Enhanced Matrix Pencil (MEMP) algorithm described in Innovation Patent No. 2008101237. The signal strength of microwaves at a patch antenna 205, x(m:n), in the far field receiver array 202 with an element spacing of Δₓ, Δ_{y}, is represented by the following equation:

$$x ( m \text{:} n ) = {\sum }_{i = 1}^{1} {A}_{i} exp ( {jγ}_{i} + j 2 π n {Δ}_{y} sin {θ}_{i} sin {ψ}_{i} + j2π m {Δ}_{x} sin {θ}_{i} cos {ψ}_{i} )$$

where:
i=microwave signal from targets 1 to i,
Aᵢ=amplitude
γᵢ=phase
ψᵢ=elevation of target i
θᵢ=azimuth of target i

The received signal from each patch antenna 205 is assembled into an enhanced matrix using a partition and stack process (detailed in Y. Hua, “Estimating Two-Dimensional Frequencies by Matrix Enhancement and MEMP”, IEEE Trans. On Signal Processing, Vol. 40, No. 9, pp. 2267-2280, September 1992). An estimate of the number of insects is made by applying a Singular Value Decomposition (SVD) to the enhanced matrix to determine signal and noise subspaces. Eigenvalues associated with the signal subspaces are determined by matrix inversion. The eigenvalues determine azimuths and elevations of all the signals due to insects in the signal subspace. The azimuth and elevation for individual insects is obtained by a pairing algorithm (detailed in S. Burintramart and T. Sarkar, “Target Localisation in Three Dimensions”, In Chandran, Advances in Direction of Arrival Estimation, Artech House 2005. ISBN-10: 1596930047). Amplitude and phase information may also be estimated using this process.

MEMP performs best with an ideal, uniform rectangular array however in practice the array is not ideal (imperfect) due to limitations in element placement, imbalances in the phase and amplitude applied to each patch 205 in the array and mutual coupling between elements in the array.

Before the MEMP can be applied to the imperfect array a transformation is applied to the received signals by computing a difference between the response of an ideal array and the response during a calibration performed on the far field array 202. The transformation matrix, T, is calculated as a least mean squared solution to (see P. Nyberg, “Antenna Array Mapping for DOA Estimation in Radio Signal Reconnaissance,” Ph.D. Thesis, Kungliga Tekniska Högskolan, 2005):

T=arg min_{T}∥TA_{R}(φᵢ, θᵢ)−A_{V}(φᵢ, θᵢ)∥_{F}²

where:
A_{R} and A_{V}=array manifolds from a set of angles generated from simulation or calibration data for the real and virtual array respectively.

The transformation matrix is best suited to a subset of directions of arrival, over which it can be calculated. The subset is referred to as a sector. In one embodiment of the present invention an azimuth sector is limited to π/2 and an elevation sector is limited to π/4 as the accuracy of the transformation reduces with larger sector sizes. Any signals arriving from outside a sector are not transformed properly resulting in interference signals within the sector and therefore need to be suppressed before they are transformed. This is particularly the case when an out-of sector insect is in the far field, whilst the in sector target is in the near field because the far field signals have less wavefront curvature, and result in larger singular values despite the signals being weaker. The MEMP algorithm relies on phase and amplitude information and thus traditional filtering techniques such as multiply and add are inappropriate. In one embodiment of the present invention signal cancellation is used by directing a narrow beam Chebyshev filter towards the unwanted insect. The magnitude and phase of the target is computed and an equal but opposite phase signal is added to the received signal and may achieve 20 dB of attenuation. This is in addition to the out-of-sector suppression afforded by the transmitter beamforming. This signal cancellation and/or beamforming may be performed adaptively i.e. performed more than once.

Using the far field receiver array 202, a user of the insect detection system 100 may determine a location of insects within a wall or other applicable area under examination from a distance of approximately 620 mm to 1500 mm. Once the approximate location is determined, a detailed, high resolution image of the insects may be determined using a near field insect detector at distances typically less than about 620 mm and usually at a distance of 100 mm. For example the insect detector described in Australian Innovation Patent AU 2008101237 may be used.

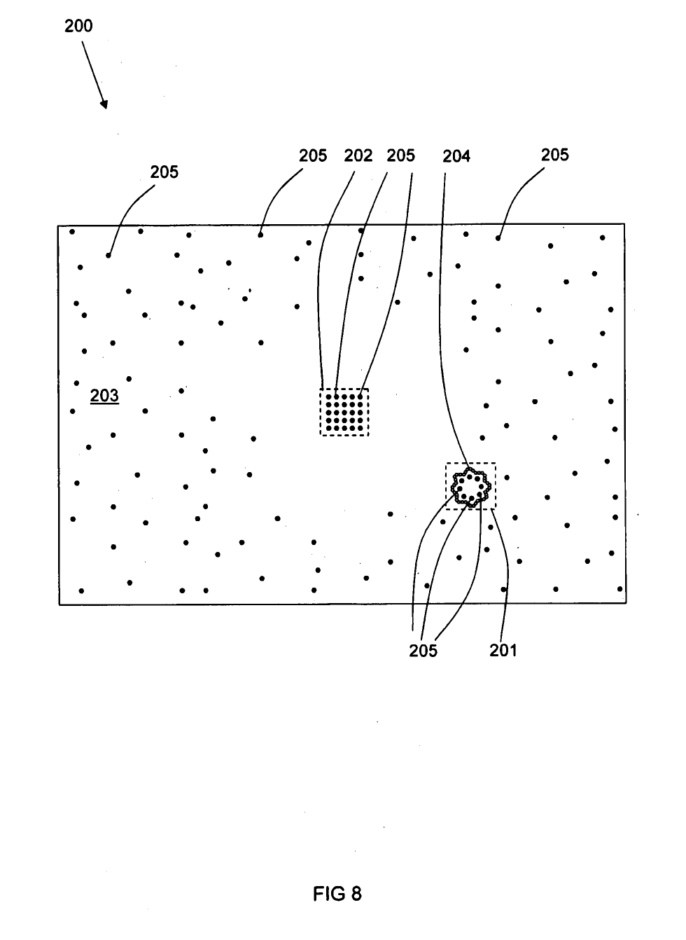

In a second embodiment of the invention, the antenna array 200 is modified to include a near field array 203 as shown in FIG. 8 alleviating the need for a separate near field termite detector. The near field receiver array 203 includes 112 randomly distributed patch antennas 205 on the PCB. The near field receiver array 203 may include any other suitable number of patch antennas 205 depending on the requirements for a particular design and the speed of the FPGA 550 and the CPU 560.

Microwave signals received by the near field receiver array 203 are connected to a 16:1 multiplexer connected to 14 receivers 400. In a similar manner to the far field receiver array 202, the patch antennas 205 in the near field receiver array 203 are connected to a demodulator 402 via a splitter 401.

Signals received by the near field array 203 are demodulated to extract the I and Q 20 kHz signals and the demodulated signals are converted to digital signals by the ADC 403. The digitised signals are then passed to the processor 500 for analysis. The received signals are focused using the technique detailed in a book written by H. L. Van Trees, Detection, Estimation and Modulation Theory, Part IV, Optimum Array Processing, Wiley, NY, 2002, ISBN-10: 0471093904 and produces high resolution 3D images of the insects on the screen of the computer 570. Focusing is achieved by applying a spherical phase profile across the array, so that signals emanating from a point target at a focus point are received with equal phase at all the array elements. The spherical phase profile is unique for each focus point, and hence an image of the target space can be produced. Targets at positions other than the focus point produce weak, defocused signals, described by an ambiguity function or a point-spread response. Focusing, does not rely on a plane wave assumption. Instead, focussing aligns the phases of signals arriving from a point in a 3D space, to detect and locate point targets.

Termites move relatively slowly, at typically 5 mm/sec, and therefore a 10 Hz frame rate is sufficient for real-time imaging which has been proven over years of field experience. The number of calculations required by an imaging algorithm is determined by the number of voxels in the image.

The number of 27 mm³ voxels in a hemisphere of radius 620 mm is 18.9×10⁶, and is an upper bound. By pre-computing phase shifts, one multiply accumulate (MAC) operation is required for each sub-array element for focusing each voxel.

The minimum number of sub-array elements is determined by acceptable alias suppression which in one embodiment of the invention is between 64 and 128 array elements. Therefore, 20 GigaMAC/s is sufficient for realtime imaging. Another requirement is acceptable spatial resolution, which depends on an aperture area of the near field array 203.

The CPU 560 may also be used to provide additional analysis of the received signals, together with the FPGA 550 from the far field receiver array 202 and the near field receiver array 203. The CPU 560 communicates with the FPGA 550 and further controls the process of transmitting, receiving and analysing the received signals. In one embodiment, the CPU 560 communicates with a computer 570. The computer 570 receives images according to the received signals and displays the images on a screen to a user. The computer 570 may be a desktop, laptop or PDA or any other suitable device. The computer 570 is connected to the CPU 560 via a wired or wireless connection, such as Ethernet, RS232, 802.11, Bluetooth or any other suitable connection. It should also be appreciated that a display may be connected to the processor 500 directly.

In use an operator of the insect imaging system 100 scans an area such as a wall, floor or ceiling of a building in order to detect insects. The operator places the insect imager system 100 into a wide area detection mode at a distance of approximately 620 mm to 1500 mm from the surface of the measurement area. The system 100 transmits microwaves into the area of interest and receives and analyses received signals and displays the bearings of insect activity on the screen of the computer 570.

The operator may then examine any areas of concern by placing the system 100 into a high resolution imaging mode. In this case the system 100 transmits uncoded signals into the wall at a distance of approximately 100 mm, and analyses the data on the screen of the computer 570 in order to determine which direction the insects are travelling and the species of insect. The former is important, so that the operator can track the termites back to the nest, where effective treatment can be administered. The high resolution image can also assist in assessing the structural damage to the building. Alternatively, coded signals may be transmitted and used to resolve any potential ambiguities. The present invention has many advantages over prior art insect imaging systems including:
1) A large area may be scanned more quickly and efficiently; and
2) A detailed, analysis may be performed in an area of interest, aiding individual insects' movement and species identification.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this invention is intended to embrace all alternatives, modifications and variations of the present invention that have been discussed herein, and other embodiments that fall within the spirit and scope of the above described invention.

1. An insect detection system including:
a transmitter array that transmits microwave signals into a region;
a far field receiver array that receives far field signals reflected or scattered from the region illuminated by the transmitted microwave signals;
a processor that processes the received microwave signals; and
a display that displays images according to the processed far field signals.

2. The insect detection system of claim 1, wherein at least one of the transmitter array and the far field receiver array are fabricated on at least one printed circuit board.

3. The insect detection system of any one of claim 1 or 2, wherein at least one of the transmitter array and the far field receiver array include a plurality of patch antennas.

4. The insect detection system of claim 3 wherein each patch antenna includes two substantially orthogonal elements to transmit or receive arbitrary polarizations of the microwave signals.

5. The insect detection system of any one of claims 1 to 4, wherein each transmitted microwave signal is modulated in time.

6. The insect detection system of claim 5, wherein the modulation is IQ (In-phase and Quadrature) modulation.

7. The insect detection system of any one of claims 1 to 6, wherein the transmitter array is calibrated using a calibration target.

8. The insect detection system of claim 7, wherein as a result of the calibration, a signal of equal and opposite phase to a signal coupling patch antennas, is applied to each patch antenna to reduce imperfections in the transmitter array.

9. The insect detection system of any one of claims 5 to 8, wherein each substantially orthogonal element of the transmitter array transmits microwave signals encoded with orthogonal codes.

10. The insect detection system of claim 9, wherein the orthogonal codes are derived from a Hadamard matrix.

11. The insect detection system of claim 10, wherein the orthogonal codes are constructed from cyclic shifts of a pseudo-noise sequence.

12. The insect detection system of claim 11 wherein the pseudo noise sequence is a quadratic residue sequence, to which one extra bit has been appended.

13. The insect detection system of any one of claims 9 to 12, wherein each encoded far field signal received by the substantially orthogonal elements of the far field receiver array is decoded by correlation.

14. The insect detection system of any one of claims 1 to 13, wherein the received signal is used to determine whether the received signal is due to an insect, or a part of a building structure being examined.

15. The insect detection system of claim 1, wherein the far field image processing includes a direction of arrival (DOA) method for image acquisition.

16. The insect detection system of claim 15, wherein the DOA method uses a Modified Enhanced Matrix Pencil (MEMP) algorithm.

17. The insect detection system of any one of claims 4 to 16, wherein the signals from each transmitter element are beamformed at the receiver before processing by the DOA algorithm.

18. The insect detection system of claim 17, wherein the transmitter signal beamforming is performed to null out undesirable targets, artefacts, reflections and/or clutter.

19. The insect detection system of any one of claims 16 to 18, wherein a Chebyshev filter cancellation algorithm is used to reduce signals from unwanted directions in conjunction with transmitter beamforming before processing by the DOA algorithm.

20. The insect detection system of claim 18 or 19, wherein the signal cancellation and/or beamforming is performed adaptively.

21. The insect detection system of any one of claims 1 to 20, further including a near field receiver array that receives near field signals reflected or scattered from the transmitted microwave signals.

22. The insect detection system of claim 21, wherein the received near field signals are processed and are displayed on the display according to processed near field signals.

23. The insect detection system of claim 21 or 22, wherein at least one of the transmitter array, the far field receiver array and the near field receiver array are fabricated on at least one printed circuit board.

24. The insect detection system of claims 21 to 23, wherein the near field receiver array includes a plurality of patch antennas.

25. The insect detection system of claim 24 wherein each patch antenna includes two substantially orthogonal elements to receive arbitrary polarizations of the microwave signals.

26. An insect detection system including:
a transmitter array that transmits microwave signals into a region;
a far field receiver array that receives far field signals reflected or scattered from the region illuminated by the transmitted microwave signals;
a near field receiver array that receives near field signals reflected from the transmitted microwave signals;
a processor that processes the received microwave signals; and
a display that displays images according to the processed far field signals and/or the near field signals.

27. A method of detecting insects including the steps of:
transmitting microwave signals into a region;
receiving far field signals reflected or scattered from the region illuminated by the transmitted microwave signals;
processing the received microwave signals; and
displaying images according to the processed far field signals.

28. The method of claim 27 including the step of :
modulating the transmitted microwave signal.

29. The method of claim 28 including the step of:
applying a signal of equal and opposite phase to a signal coupling patch antennas, to each patch antenna to reduce imperfections in the transmitter array.

30. The method of claim 29 including the step of:
encoding each substantially orthogonal element of the transmitter array with orthogonal codes.
